(19) United States
(12) Patent Application Publication
(10) Pub. No.: US 2005/0214607 A1
(43) Pub. Date: Sep. 29, 2005

(54) Polymer electrolyte fuel cell power generation system and stationary co-generation system using the same

(76) Inventors: Jinichi Imahashi, Hitachi (JP); Katsunori Nishimura, Hitachiota (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/058,373

(22) Filed: Feb. 16, 2005

(30) Foreign Application Priority Data
Mar. 25, 2004 (JP) 2004-088461

(51) Int. Cl. H01M 8/04; H01M 8/06; H01M 8/10

(52) U.S. Cl. 429/23; 429/19; 429/26; 429/32

(57) ABSTRACT

While a fuel cell is refreshed without interrupting a power generation by the fuel cell, a polymer electrolyte membrane fuel cell power generation system capable of maintaining performance of the fuel cell under stable condition for a long time period is provided. In the polymer electrolyte membrane fuel cell power generation system, when a load detected by a power detecting unit of a power converting unit is not equal to a time rated load, a control unit drives a fuel cell unit for a predetermined time period in a power generation mode corresponding to the rated load.

### BACKGROUND OF THE INVENTION

1. Field of the Invention

The present invention is related to a polymer electrolyte membrane fuel cell power generation system, and also, to a home-use stationary distributed power supply system with employment of the polymer electrolyte membrane fuel cell power generation system.

2. Description of the Related Art

Fuel cells correspond to such power generation systems that chemical energy owned by both fuel gas and oxidant gas is directly generated as electric energy by way of an electrochemical reaction occurred between the fuel gas such as hydrogen, and the oxidant gas such as air, or oxygen. Fuel cells are mainly constituted by anodes which are reacted to hydrogen and cathodes which are reacted to air, while both the anodes and the cathodes sandwich therebetween electrolyte. Various sorts of fuel cells are available, depending upon utilizations and characteristics, for instance, a phosphoric acid type fuel cell, a molten carbonate type fuel cell, a solid-state oxide type fuel cell, a polymer electrolyte membrane fuel cell, and the like. Among these fuel cells, in particular, a polymer electrolyte membrane fuel cell featured by employing a polymer film as electrolyte owns the following merits. That is, since output power density of the polymer electrolyte membrane fuel cell is large, this fuel cell can be easily made compact, and furthermore, since the polymer electrolyte membrane fuel cell can be operated under low temperature (approximately 70 to 80 degrees) condition, deteriorations as to performance and characteristics thereof which are caused by initiating/stopping this fuel cell are low, so that long lifetime of this polymer electrolyte membrane fuel cell can be realized. As a consequence, very wide applications can be expected for such polymer electrolyte membrane fuel cells as mobile-purpose power supplies such as automobiles, and stationary distributed power supplies, or home-use distributed power supplies. Among these various utilization fields, distributed power supply systems (for instance, co-generation power generation systems) with employment of such polymer electrolyte membrane fuel cells correspond to such power supply systems that both electric energy generated by the polymer electrolyte membrane fuel cells and heat which is produced by way of electrochemical reactions during power generations are collected at the same time so as to effectively utilize energy.

In a distributed power supply system using the above-described polymer electrolyte membrane fuel cell, since 50,000 hours, or more hours have been requested as a lifetime of this distributed power supply system, the following items are desirable. That is, lowering of output voltages and lowering of power generation efficiencies should be reduced as low as possible, which may give an adverse influence to durability of the distributed power supply system. In an actual case, there are many possibilities that in this distributed power supply system, the polymer electrolyte membrane fuel cell is operated under a load (will be referred to as “low load” hereinafter) of ranges from 80% to 30% with respect to the rated load. When this polymer electrolyte membrane fuel cell is operated under low load condition for a long time period, since the fuel cell performs power generations in correspondence with loads, liquid water tends to be gradually stored inside a separator which is provided between anode and cathode which is located adjacent to anode. The storage of the water inside the separator is caused by the following reason. That is, since an amount of supplied gas is decreased in correspondence with the loads, liquid water in a channel of a gas channel which is provided within the separator cannot be sufficiently exhausted by the supplied gas. Then, when the water components are stored in the channel for the gas channel, flows of the gas become unequal to each other. As a result, a distribution of the gas supplied to the electrodes becomes unequal, which may conduct that the output voltage is varied in an irregular manner and the output voltage is lowered. Accordingly, there is such a problem that the power generations cannot be performed under stable condition with respect to the distributed power supply system which continuously generates the electric power for the long time period.

Further, when this polymer electrolyte membrane fuel cell is operated under the low load condition for a long time period, since the hydrogen supply amount of the fuel gas is decreased in correspondence with the low load, a very small amount of either air or oxygen is penetrated (gas cross) from the cathode through the polymer electrolyte film, and then, is mixed into the anode. The very small amount of this mixed air, or mixed oxygen may oxidize the electrode catalyst of the anode to form a localized cell on the surface of the electrode catalyst, which may cause both a formation of an oxidation film and cohesion of the electrode catalyst. More specifically, since reactions becomes inactive on the surface covered by this oxidation film, the performance of the electrode catalyst is lowered, so that the cell performance is deteriorated, for example, the output voltage of the fuel cell is lowered. This phenomenon may cause such a problem that the stable power generations cannot be carried out as to such a distributed power supply system which originally generates electric power under stable condition for a long time period. As a result, various recovering methods capable of recovering cell performance have been requested in such a case that electrode performance is deteriorated and an output voltage of a distributed power supply system is lowered.

Under such a circumstance, very recently, several recovering methods have been proposed (for instance, JP-A-2003-123812, pages 2 to 3) in such a case that in a long-term continuous operation of a polymer electrolyte membrane fuel cell, metal ions and contaminative substances which are melted from a structural member such as a separator are stored within the polymer electrolyte membrane fuel cell, which may deteriorate the performance of this polymer electrolyte membrane fuel cell and durability thereof. The recovering method disclosed in JP-A-2003-123812 corresponds to such a recovering method that as to the polymer electrolyte membrane fuel cell whose performance has been lowered, the characteristics of this polymer electrolyte membrane fuel cell may be recovered by loading this fuel cell in high current density, or by reversing the energizing direction, or by supplying acid water whose “pH” is lower than, or equal to 7 to the gas path so as to clean this gas path.

However, in accordance with the conventional method for recovering the characteristic of the polymer electrolyte membrane fuel cell disclosed in JP-A-2003-123812, while the polymer electrolyte membrane fuel cell is operated in the continuous mode, in such a case that the performance of this fuel cell is deteriorated, any one of the below-mentioned three solving means is carried out:
a) The fuel cell is loaded in the high current density.
b) The current energizing direction of the fuel cell is reversed.
c) The acid water whose “pH” is lower than, or equal to 7 is supplied to the gas path so as to clean the gas path.

As a consequence, in order to recover the cell performance in accordance with this conventional recovering method, the large current must flow through the fuel cell for a time being, or the operation of this fuel cell must be temporarily stopped. This conventional recovering method owns the following problem. That is, the operability as to such a distributed power supply system which is originally driven under stable condition and in a continuous manner for a long time period would be deteriorated.

Also, in the above-described conventional method for recovering the characteristic of the polymer electrolyte membrane fuel cell disclosed in JP-A-2003-123812, the above-described problems cannot be still solved. That is, since the water is stored inside the separator due to the low load operation for the long time period, or the performance of the electrode is deteriorated due to the oxidation of the electrode catalyst of the anode, the performance of the fuel cell is deteriorated, for example, the output voltage is lowered.

### SUMMARY OF THE INVENTION

An object of the present invention is to provide a polymer electrolyte membrane fuel cell power generation system capable of maintaining performance of the fuel cell under stable condition for a long time period is provided, while a fuel cell is refreshed without interrupting a power generation by the fuel cell. Also, an object of the present invention is to provide a home-use stationary distributed power supply system with employment of the above-described polymer electrolyte membrane fuel cell power generation system.

A polymer electrolyte membrane fuel cell power generation system, recited in claim 1 of the present invention, is featured by such a polymer electrolyte membrane fuel cell power generation system comprising: a fuel cell unit equipped with a fuel cell stack for stacking a unit cell which is arranged by a polymer electrolyte membrane, both anode and cathode which are provided by sandwiching therebetween the polymer electrolyte membrane, a first separator having a channel for supplying/exhausting fuel gas, which is provided outside the anode, and also, a second separator having a channel for supplying/exhausting air, which is provided outside the cathode; a hydrogen generating apparatus unit for supplying the fuel gas to the fuel cell unit; an oxidant gas supplying unit for supplying oxidant gas to the fuel cell unit; a power converting unit for converting DC power generated from the fuel cell unit into AC power so as to supply the AC power to a load; a heat collecting unit for collecting heat which is produced from the fuel cell unit; a load detecting unit for detecting a load supplied by the power converting unit; and a control unit for controlling the fuel cell unit, the hydrogen generating apparatus unit (reformer), the oxidant gas supplying unit, the power converting unit, and the heat collecting unit; wherein: the control unit owns a function capable of controlling that when a load detected by the load detecting unit is not equal to a predetermined time rated load, the fuel cell unit is operated in a power generation mode corresponding to the predetermined time rated load.

A polymer electrolyte membrane fuel cell power generation system, recited in claim 2 of the present invention, is featured by that the control unit owns a function capable of controlling that when the fuel cell unit is operated in the power generation mode corresponding to the predetermined time rated load, both an amount of the fuel gas and an amount of the oxidant gas which are supplied to the fuel cell unit are supplied at a rate of 100 to 200% of gas supply amounts which correspond to a power generation mode of a rated load.

A polymer electrolyte membrane fuel cell power generation system, recited in claim 3 of the present invention, is featured by such a polymer electrolyte membrane fuel cell power generation system comprising: a fuel cell unit equipped with a fuel cell stack for stacking a unit cell which is arranged by a polymer electrolyte membrane, both anode and cathode which are provided by sandwiching therebetween the polymer electrolyte membrane, a first separator having a channel for supplying/exhausting fuel gas, which is provided outside the anode, and also, a second separator having a channel for supplying/exhausting air, which is provided outside the cathode; a hydrogen generating apparatus unit for supplying the fuel gas to the fuel cell unit; an oxidant gas supplying unit for supplying oxidant gas to the fuel cell unit; a power converting unit for converting DC power generated from the fuel cell unit into AC power so as to supply the AC power to a load; a heat collecting unit for collecting heat which is produced from the fuel cell unit; a voltage detecting unit for detecting a cell voltage of the fuel cell unit; and a control unit for controlling the fuel cell unit, the hydrogen generating apparatus unit, the oxidant gas supplying unit, the power converting unit, and the heat collecting unit; wherein: the control unit owns a function capable of controlling that when a variation of the cell voltage detected by the voltage detecting unit is higher than, or equal to a predetermined voltage, both an amount of the fuel gas and an amount of the oxidant gas which are supplied to the fuel cell unit are supplied at a rate of 100 to 200% of gas supply amounts which correspond to a power generation mode of a rated load.

A polymer electrolyte membrane fuel cell power generation system, recited in claim 4 of the present invention, is featured by such a polymer electrolyte membrane fuel cell power generation system comprising: a fuel cell unit equipped with a fuel cell stack for stacking a unit cell which is arranged by a polymer electrolyte membrane, both anode and cathode which are provided by sandwiching therebetween the polymer electrolyte membrane, a first separator having a channel for supplying/exhausting fuel gas, which is provided outside the anode, and also, a second separator having a channel for supplying/exhausting air, which is provided outside the cathode; a hydrogen generating apparatus unit for supplying the fuel gas to the fuel cell unit; an oxidant gas supplying unit for supplying oxidant gas to the fuel cell unit; a power converting unit for converting DC power generated from the fuel cell unit into AC power so as to supply the AC power to a load; a heat collecting unit for collecting heat which is produced from the fuel cell unit; a voltage detecting unit for detecting a cell voltage of the fuel cell unit; and a control unit for controlling the fuel cell unit, the hydrogen generating apparatus unit, the oxidant gas supplying unit, the power converting unit, and the heat collecting unit; wherein: the control unit owns a function capable of controlling that when a cell voltage detected by the voltage detecting unit is lower than, or equal to a predetermined voltage, both an amount of the fuel gas and an amount of the oxidant gas which are supplied to the fuel cell unit are supplied at a rate of 100 to 200% of gas supply amounts which correspond to a power generation mode of a rated load.

A polymer electrolyte membrane fuel cell power generation system, recited in claim 5 of the present invention, is featured by that in the polymer electrolyte membrane fuel cell power generation system recited in claim 4, the control unit owns a function capable of controlling that when the cell voltage detected by the voltage detecting unit is lower than, or equal to the predetermined voltage, fuel gas is supplied from the hydrogen generating apparatus unit to the fuel cell unit, the concentration of which is set to a rate of 100 to 200% of such fuel gas concentration corresponding to the power generation mode of the rated load.

A polymer electrolyte membrane fuel cell power generation system, recited in claim 6 of the present invention, is featured by that in the polymer electrolyte membrane fuel cell power generation system recited in any one of claim 1 to claim 5, the power converting unit is comprised of a rechargeable secondary battery; and the control unit owns a function capable of controlling that when electric power generated by the fuel cell unit becomes excessive with respect to the load power detected by the load detecting unit, the excessive power is charged into the secondary battery, whereas when electric power generated by the fuel cell unit becomes short with respect to the load power detected by the load detecting unit, the shortage power is discharged from the secondary battery.

A polymer electrolyte membrane fuel cell power generation system, recited in claim 7 of the present invention, is featured by that in the polymer electrolyte membrane fuel cell power generation system recited in any one of claim 1 to claim 5, the power converting unit is comprised of a rechargeable capacitor; and the control unit owns a function capable of controlling that when electric power generated by the fuel cell unit becomes excessive with respect to the load power detected by the load detecting unit, the excessive power is charged into the rechargeable capacitor, whereas when electric power generated by the fuel cell unit becomes short with respect to the load power detected by the load detecting unit, the shortage power is discharged from the rechargeable capacitor.

A polymer electrolyte membrane fuel cell power generation system, recited in claim 8 of the present invention, is featured by that in the polymer electrolyte membrane fuel cell power generation system recited in any one of claim 1 to claim 7, the heat collecting unit is comprised of a heating means; and the control unit owns a function capable of controlling that when electric power generated by the fuel cell unit becomes excessive with respect to the load power detected by the load detecting unit, the excessive power is converted into heat by the heating means so as to collect the heat.

A home-use stationary distributed power supply system, recited in claim 9 of the present invention, is featured by such a home-use stationary distributed power supply system comprising: the polymer electrolyte membrane fuel cell power generation system recited in any one of claim 1 to claim 8.

In accordance with the invention recited in claim 1, while the fuel cell is refreshed without interrupting the power generation of the fuel cell, the stable cell performance can be maintained for a long time period.

In accordance with the invention recited in claim 2, while the fuel cell is refreshed without interrupting the power generation of the fuel cell, the stable cell performance can be maintained for a long time period.

In accordance with the invention recited in claim 3, while the fuel cell is refreshed without interrupting the power generation of the fuel cell, the stable cell performance can be maintained for a long time period.

In accordance with the invention recited in claim 4, while the fuel cell is refreshed without interrupting the power generation of the fuel cell, the stable cell performance can be maintained for a long time period.

In accordance with the invention recited in claim 5, while the fuel cell is refreshed without interrupting the power generation of the fuel cell, the stable cell performance can be maintained for a long time period.

In accordance with the invention recited in claim 6, while the fuel cell is refreshed without interrupting the power generation of the fuel cell, the stable cell performance can be maintained for a long time period.

In accordance with the invention recited in claim 7, while the fuel cell is refreshed without interrupting the power generation of the fuel cell, the stable cell performance can be maintained for a long time period.

In accordance with the invention recited in claim 8, while the fuel cell is refreshed without interrupting the power generation of the fuel cell, the stable cell performance can be maintained for a long time period.

In accordance with the invention recited in claim 9, while the fuel cell is refreshed without interrupting the power generation of the fuel cell as the home-use stationary distributed power supply system, the stable cell performance can be maintained for a long time period.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining an arrangement of a polymer electrolyte membrane fuel cell power generation system according to the present invention.

FIG. 2 is a diagram for explaining a flow of fuel gas of the polymer electrolyte membrane fuel cell power generation system according to the present invention.

FIG. 3 is a diagram for explaining constructions as to a fuel cell stack and a unit fuel cell employed in the polymer electrolyte membrane fuel cell power generation system according to the present invention.

FIG. 4 is a flow chart for representing a refresh processing routine 1 of the polymer electrolyte membrane fuel cell power generation system according to the present invention.

FIG. 5 is a graph for representing a relationship between an output voltage of the fuel cell stack and refresh processing time in the case that the refresh processing routine 1 is executed at 350 hours after the operation of the polymer electrolyte membrane fuel cell power generation system according to the present invention has been commenced.

FIG. 6 is a graph for representing a relationship between an output voltage of the fuel cell stack and refresh processing time in the case that the refresh processing routine 1 is firstly executed at 350 hours after the operation of the polymer electrolyte membrane fuel cell power generation system according to the present invention has been commenced.

FIG. 7 is a flow chart for representing a refresh processing routine 2 of the polymer electrolyte membrane fuel cell power generation system according to the present invention.

FIG. 8 is a graph for representing a relationship between an output voltage of the fuel cell stack and refresh processing time in the case that the refresh processing routine 2 is executed at 750 hours after the operation of the polymer electrolyte membrane fuel cell power generation system according to the present invention has been commenced.

FIG. 9 is a flow chart for representing a refresh processing routine 3 of the polymer electrolyte membrane fuel cell power generation system according to the present invention.

FIG. 10 is a graph for representing a relationship between an output voltage of the fuel cell stack and refresh processing time in the case that the refresh processing routine 3 is executed at 350 hours after the operation of the polymer electrolyte membrane fuel cell power generation system according to the present invention has been commenced.

FIG. 11 is a flow chart for representing a refresh processing routine 4 of the polymer electrolyte membrane fuel cell power generation system according to the present invention.

FIG. 12 is a graph for representing a relationship between an output voltage of the fuel cell stack and refresh processing time in the case that the refresh processing routine 4 is executed at 350 hours after the operation of the polymer electrolyte membrane fuel cell power generation system according to the present invention has been commenced.

FIG. 13 is a flow chart for representing a refresh processing routine 5 of the polymer electrolyte membrane fuel cell power generation system according to the present invention.

FIG. 14 is a graph for representing a relationship between an output voltage of the fuel cell stack and refresh processing time in the case that the refresh processing routine 5 is executed at 350 hours after the operation of the polymer electrolyte membrane fuel cell power generation system according to the present invention has been commenced.

FIG. 15 is a diagram for representing an example in which the polymer electrolyte membrane fuel cell power generation system according to the present invention has been employed in a portion of an arrangement of a home-use stationary distributed power supply as an application example of the power generation system.

### DETAILED DESCRIPTION OF THE EMBODIMENTS

Next, a detailed explanation is made of an embodiment mode of a polymer electrolyte membrane fuel cell power generation system according to the present invention.

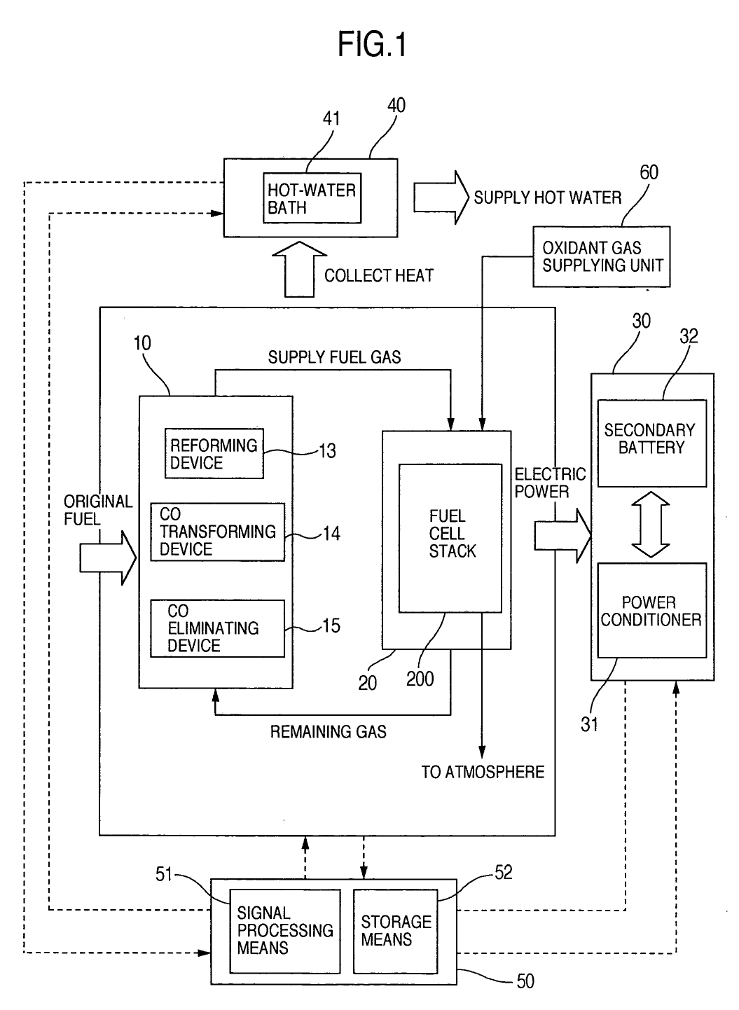

FIG. 1 indicates a structural diagram of the polymer electrolyte membrane fuel cell power generation system 1 according to the present invention.

In FIG. 1, the polymer electrolyte membrane fuel cell power generation system 1 is mainly arranged by a hydrogen generating apparatus unit 10, a fuel cell unit 20, a power converting unit 30, a hot-water storing/hot-water supplying unit 40, a control unit 50, and an oxidant gas supply unit 60.

The hydrogen generating apparatus ex. (reformer) unit 10 produces hydrogen by a reforming device 13, and supplies this produced hydrogen to the fuel cell unit 20 as a fuel, while the reforming device 13 reforms either town gas, LPG, and natural gas of an original gas, or various sorts of hydrocarbon-series fuels such as lamp oil, gasoline, and methanol so as to produce hydrogen. In the fuel cell unit 20, electric power is generated by a fuel cell stack 200 of this fuel cell unit 20 based upon an electrochemical reaction between air and hydrogen of the fuel supplied from the hydrogen generating apparatus unit 10. The power converting unit 30 is arranged by a power conditioner 31, and a power storage means 32. In the power conditioner 31, DC power which has been obtained by the generation of the fuel cell unit 20 is boosted by a chopper, and then, this boosted DC power is converted into AC power by an inverter. The power storage means 32 is realized by a rechargeable secondary battery, or a capacitor. In the hot-water storing/hot-water supplying unit 40, exhaust heat of either the hydrogen generating apparatus unit 10 or the fuel cell unit 20 is stored as hot water in a hot water bath 41, and the stored hot water is supplied to a user within a home, or the like. It should be noted that a heater capable of collecting excessively generated power as thermal energy may be alternatively provided within the hot water bath 41. The control unit 50 is arranged by logic circuits mainly containing a microcomputer. The control unit 50 contains a signal processing means 51 for performing a signal process operation by a CPU, a storage means 52 constructed of a memory such as a ROM and a RAM, and also, input/output ports (not shown) for inputting/outputting various sorts of signals. The control unit 50 controls an entire system of the polymer electrolyte membrane fuel cell power generation system 1. While the microcomputer and the like are utilized, this control unit 50 executes a control operation of the power converting unit 30; control operations as to operations of the hydrogen generating apparatus unit 10, of the fuel cell unit 20, and of the oxidant gas supplying unit 60, which are operated so as to generate electric power in correspondence with a load which is required for this polymer electrolyte membrane fuel cell power generation system 1; a control operation of the hot-water storing/hot-water supplying unit 40; and a control operation as to an auxiliary appliance (not shown) such as an air blower and a water pump. The oxidant gas supplying unit 60 supplies oxidant gas such as air to the fuel cell unit 20 by operating the air blower.

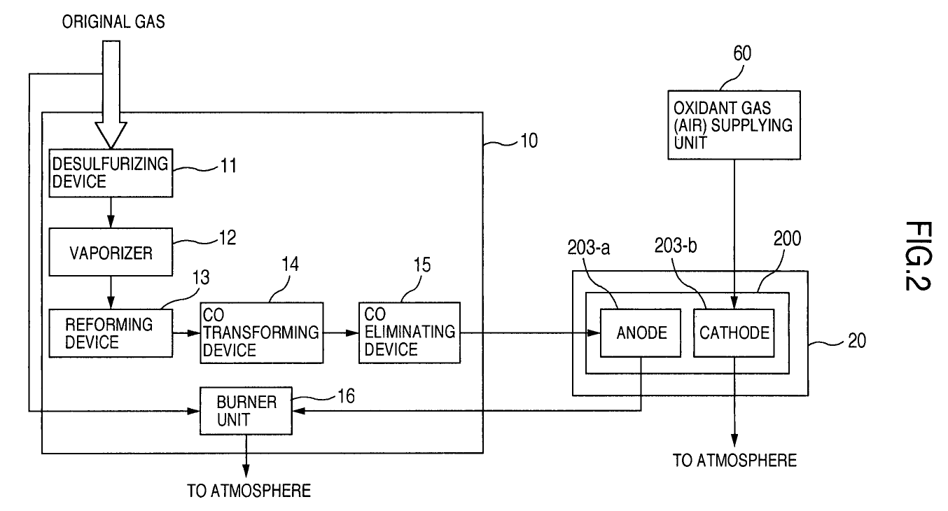

Next, an embodiment mode of the polymer electrolyte membrane fuel cell power generation system 1 according to the present invention will now be described more in detail based upon a flow of gas shown in FIG. 2.

As to an original fuel corresponding to various sorts of hydrocarbon fuels such as city gas, LPG, natural gas, or lamp oil, gasoline, methanol, which are supplied to the hydrogen generating apparatus unit 10, a sulfur component is eliminated by a desulfurizing device 11 by way of a catalyst. The sulfur component has been contained in the original fuel as a small adding material, and may lower catalyst performance of the reforming device 13, so that this sulfur component is harmful. Next, the original fuel from which this sulfur component has been eliminated is vaporized and temperature-increased in combination with water added in the vaporizer 12, and then, the resulting original gas is fed to the reforming device 13.

Gas mixed with the original fuel and the water vapor, which has been fed to the reforming device 13, is reformed/reacted in the reforming device 13, so that hydrogen rich gas (may also be called as “reformed gas”, but will be referred to as “fuel gas” hereinafter) is produced. In this case, a reforming reaction catalyst which is adapted to a sort of reforming reactant (fuel) is provided in the reforming device 13. An internal temperature of the reforming device 13 is maintained at such a temperature which is suitable for a reforming reaction by controlling a heat value supplied from a burner unit 16. While a heating source of the reforming device 13 is realized by heat supplied by the burner unit 16, as fuel which is supplied to the burner unit 16, the original fuel which will be supplied to the hydrogen generating apparatus unit 10, or off gas (will be referred to as “remaining fuel gas” hereinafter) of such fuel gas which has been supplied to the fuel cell unit 20 so as to be used in the reaction.

As to a reforming reaction which is progressed in the reforming device 13, various sorts of mode systems such as a water vapor reforming system, a partially oxidizing system, and an auto-thermal system made by combining both the above-described systems may be selected. As to the catalyst equipped in the reforming device 13, such a catalyst may be selected to be employed in response to a reforming reaction selected from the above-described mode system.

As to the fuel gas produced in the reforming device 13, a carbon monoxide (CO) which diminishes a voltage of the fuel cell is removed by way of a shift reaction and by using a catalyst mounted on a CO transforming device 14 (will also be referred to as “CO shift reactor”). A shift reaction corresponds to such a reaction that both a carbon dioxide (CO₂) and hydrogen gas are produced from a carbon monoxide and water vapor, which are contained in a fuel gas. Concentration of the carbon monoxide contained in the fuel gas can be reduced to approximately 1% by this shift reaction.

As to the fuel gas derived from the CO transforming device 14, a carbon monoxide is further removed by catalyst provided in a CO removing device 15 by way of a selective oxidation reaction. The selective oxidation reaction corresponds to such a reaction that a carbon monoxide is selectively oxidized prior to hydrogen gas contained in fuel gas. By this selective oxidation reaction, concentration of the carbon monoxide can be reduced lower than, or equal to 10 ppm, and thus, lowering of the catalyst performance of the fuel cell can be prevented.

The amount of the fuel gas derived from the CO removing device 15 is controlled to such a gas amount which has been set in correspondence with a load by the control unit 50, and then, the controlled amount of the fuel gas is supplied to an anode 203-a of the fuel cell unit 20. Similarly, an amount of compressed air which is supplied from a blower (not shown) of the oxidant gas supplying unit 60 is controlled to such an air amount which has been set in correspondence with the load by the control unit 50, and then, the controlled amount of the air is supplied to a cathode 200-b of the fuel cell 20. Since the fuel cell unit 20 continuously uses both the fuel gas and the air which are supplied, this fuel cell unit 20 can continuously generate electric power based upon electromotive force which is produced by an electrochemical reaction.

The remaining fuel gas of the fuel gas which has been supplied and reacted to the anode 203-a of the fuel cell unit 20 is supplied as off gas to the burner unit 16 of the hydrogen generating apparatus unit 10, and is burned in the burner unit 16. The exhaust gas after combustion is supplied to an exhaust heat collecting apparatus (not shown), and after the heat has been collected therefrom, and the resulting exhaust gas is exhausted in the atmosphere. The remaining air of the air which has been supplied to the cathode 203-b of the fuel cell unit 20 is directly exhausted as off gas to the atmosphere, or is supplied to the exhaust heat collecting apparatus in a similar manner to that of the remaining fuel gas. After the heat is collected from this remaining air, the resultant air is exhausted in the atmosphere.

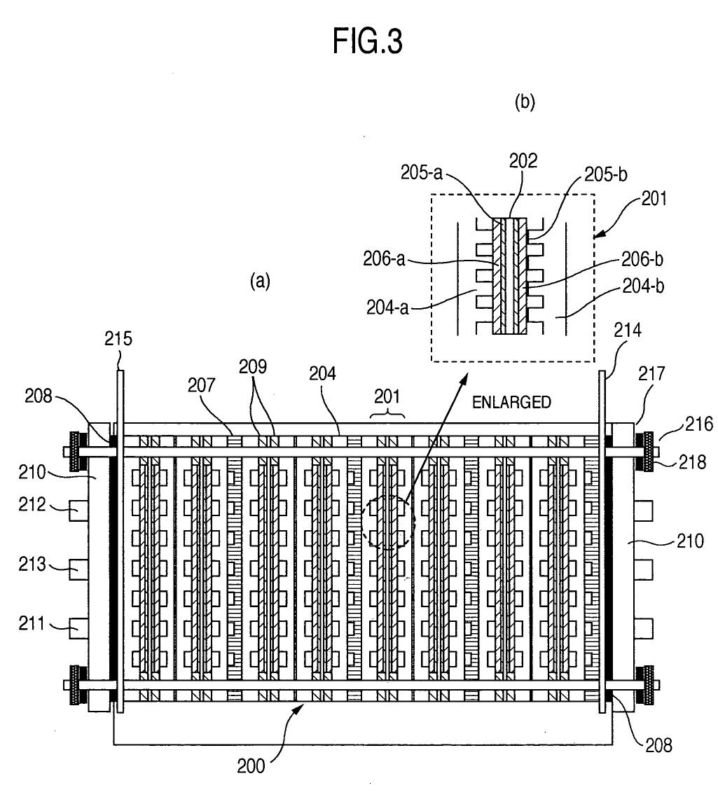

FIG. 3 is a structural diagram for explaining a basic idea and a structure of a fuel cell of the fuel cell unit 20 employed in the polymer electrolyte membrane fuel cell power generation system 1 according to the present invention. FIG. 3(a) indicates a structure of a fuel cell stack 200 of the fuel cell unit 20, and FIG. 3(b) represents a structure of a unit cell (single cell) which corresponds to a minimum structure unit of the fuel cell unit 20 of the fuel cell stack 200. This fuel cell stack 200 is realized by stacking a plurality of unit cells 201 in a stack form in order to obtain required power. As shown in the enlarge diagram of FIG. 3(b), a basic structure of the unit cell 201 is made by employing a solid-state polymer electrolyte membrane 202, anode 202-a, cathode 202-b, a first separator 204-a, and a second separator 204-b. In particular, this unit 201 is featured by that a membrane electrode assembly (will be referred to as “MEA” hereinafter) is employed as a basic structure. In this MEA, the anode 203-a and the cathode 203-b are joined to each other in an integral form on both surfaces of the polymer electrolyte membrane 202.

This polymer electrolyte membrane 202 corresponds to such a very thin film having a thickness of several tens μm, in which an ion exchange film made of a fluoride resin series called as “NAFION® (manufactured by Dupon) is mainly employed. This very thin film has a proton (hydrogen ion) conductivity (conductivity is obtained by movement of proton), and a gas separation function (this gas separation function is capable of avoid that fuel gas and oxidant gas (air) are mutually moved via electrolyte to opposite poles). As a result, the thickness of the unit cell 201 using MEA can be made thin, and the size of the fuel cell stack 200 can be made compact. It should be understood that since proton is moved within the polymer electrolyte membrane 202 in combination with water, if a sufficiently large amount of water is not present, then movement of proton is disturbed, so that the conductivity is lowered (namely, internal resistance of fuel cell become large). As a consequence, a water management is very important by which a large amount of water is secured within the polymer electrolyte membrane 202, and thus, both the fuel gas and the oxidant gas (air) must be humidified by water components at a proper temperature so as to supply the humidified fuel gas and oxidant gas to the fuel cell stack 200.

The anode 203-a is constituted by an electrode catalyst-layer 205-a and a gas diffusion layer 206-a. The cathode 203-b is constituted by an electrode catalyst layer 205-b and a gas diffusion layer 206-b. It should also be noted that both the anode 203-a and the cathode 203-b which have been constructed in the above-described manner are also called as a gas diffusion electrode. Since the operating temperature of this unit cell 201 is low, for example, approximately 70 to 80° C., both the catalyst layers 205-a and 205-b are employed so as to urge the electrochemical reaction (power generation). These catalyst layers 205-a and 205-b are manufactured in such a manner that while rare metals such as Pt, palladium, iridium, ruthenium, rhodium, gold, silver, and alloys thereof are employed as catalyst, which have been manufactured in very fine particles, these rare metal particles and alloy particles are distributed/carried on an electroconductive carbon material as a base material such as a carbon cloth, a carbon felt, and carbon paper. The gas diffusion layer 206-a has a sheet-shaped structure having a porous member in order to conduct the fuel gas supplied via the first separator 204-a to the catalyst layer 205-a, and employs such an electric conductive carbon material as a carbon cloth, a carbon felt, and carbon paper as a base. Similarly, the gas diffusion layer 206-b has a sheet-shaped structure having a porous member in order to conduct the air supplied via the second separator 204-b to the catalyst layer 205-b, and employs such an electric conductive carbon material as a carbon cloth, a carbon felt, and carbon paper as a base.

The separator 204 comprises a channel in order to supply both fuel gas and air which are required to generate power in the fuel cell stack 200. In the first separator 204-a, a channel has been formed in one surface side located opposite to the anode, by which fuel gas can be supplied and exhausted. In the separator 204-b, a channel has been formed in the other surface side located opposite to the cathode, by which air can be supplied and exhausted. Both the first separator 204-a and the second separator 204-b employ a highly electric conductive material in which carbon has been compressed as an electric conductive material having a gas non-transmitting characteristic. It should also be noted that such surfaces of the first separator 204-a and the second separator 204-b, where the channels capable of supplying/exhausting the gas have not been formed, are joined to each other so as to form an integral type separator, and this integral form separator may be alternatively employed.

A cooling water-purpose separator 207 is employed as a channel by which necessary cooling water is supplied in order to cool the fuel cell stack 200. An object to cool the fuel cell stack 200 is given as follows. That is, since the electrochemical reaction of this fuel cell generates electric power and also produces heat, the temperature within the fuel cell stack 200 must be kept at a proper temperature (approximately 70 to 80 degrees) in order to avoid that the polymer electrolyte membrane 202 is deteriorated by heat, and also to emphasize the electrochemical reaction.

The fuel cell stack 200 shown in FIG. 3(a) is manufactured as follows: That is, both a plus pole (cathode) collecting plate 214 and a minus pole (anode) collecting plate 215 are arranged at the ends, pressure is applied from the outer sides of the plus pole collecting plate 214 and the minus pole collecting plate 215 via an insulating plate 208 by an end plate 210, and then, 80 pieces of the unit cells 201 are stacked to each other via a gasket 209. In order to fix the gasket 209, such parts as a bolt 216, a plate spring 217, and a nut 218 are employed. The fuel gas is conducted into the fuel cell stack 200 by a fuel gas distributing connector 211 provided on the end plate 210. The conducted fuel gas is supplied via the channel to the anode so as to be used as reaction-purpose gas, while the channel can supply and exhaust the fuel gas and has been formed in the first separator 204-a. Then, such gas which has not been used in the reaction is again supplied to the anode of the next unit cell via the first separator 204-a so as to be used as reaction-purpose gas. Finally, the fuel gas flows through the fuel cell stack 200 by repeating the above-described operation, and then, this fuel gas is supplied as off fuel gas to the burner unit 16 of the hydrogen generating apparatus unit 10 by the fuel gas distributing connector 211 of the opposite-sided end plate 210. Similarly, air is conducted into the fuel cell stack 200 by an air distributing connector 212 formed on one end plate 210, and is sequentially supplied to the cathodes of the respective unit cells 201 via the channel capable of supplying/exhausting the air, which has been formed in the second separator 204-b, so as to be used as reaction-purpose gas. The off gas is exhausted from the fuel cell stack 200 by the air distributing connector 212 formed on the other-sided end plate 210. The cooling water is conducted into the fuel cell stack 200 by a cooling water distributing connector 213 provided on the fuel cell stack 200, and is sequentially supplied via a cooling water path formed in a cooling water-purpose separator 207 so as to cool the inside of the fuel cell stack 200. Then, this cooling water is exhausted from the fuel cell stack 200 by the cooling water distributing connector 213 provided on the other end plate 210.

Next, a description is made of a method for controlling the polymer electrolyte membrane fuel cell power generation system 1 according to the present invention.

Generally speaking, in lower power fuel cell power generation systems, a parallel operation with mains (without reverse tidal current) is carried out. Although there is such an operation method for operating a low power fuel cell power generation system under continuously constant power irrespective of increase/decrease of a load, a load following operation method is mainly employed which automatically follows increase/decrease of a load in a gradual manner. The power generation system 1 of the present invention also employs the load following operation method. A magnitude of a load is measured by an AC ammeter (not shown) which is provided in the power converting unit 30, and then, this measured signal is entered to the control unit 50. In the case that the load is varied, the control unit 50 recognizes the measured load signal, and causes the signal processing means 51 to process such a set changing signal. This set changing signal changes/sets an original fuel accepting amount, a reforming-purpose water vapor mount, a combustion-purpose air amount, a CO eliminator supplying air amount, a fuel cell stack reaction air amount, and the like into such amounts which are fitted to the load a previously-set load changing speed which has been stored in the storage means 52. The control unit 50 calculates an output value of the inverter adaptable with respect to the load based upon actually measured values as to the original fuel accepting amount, the reforming-purpose water vapor mount, the combustion-purpose air amount, the CO eliminator supplying air amount, and the fuel cell stack reaction air amount, and then, an output instruction is applied to the inverter of the power conditioner 31 by the signal processing means 51.

As a consequence, reaction gas amounts (fuel gas amount and air amount) which are sufficiently fitted to the power outputted from the inverter may be continuously supplied to the fuel cell stack 200, and thus, such a protection is performed. That is, in the case that a sufficiently large amount of the original fuel is not supplied to the fuel cell stack 200, this fuel cell stack 200 is not largely damaged based upon excessive heavy loads caused by a shortage of fuel gas and a shortage of air (oxygen). At this time, the temperature of the fuel cell stack 200 is managed within a preset temperature range which has been previously set by controlling a temperature of cooling water and an amount of the cooling water by the control unit 50 based upon a temperature which has been measured by a temperature sensor provided in the fuel cell stack 200.

### EMBODIMENTS

Next, it should be noted that although features of the present invention will be exemplified by considering embodiments, the present invention is not limited thereto.

### Embodiment 1

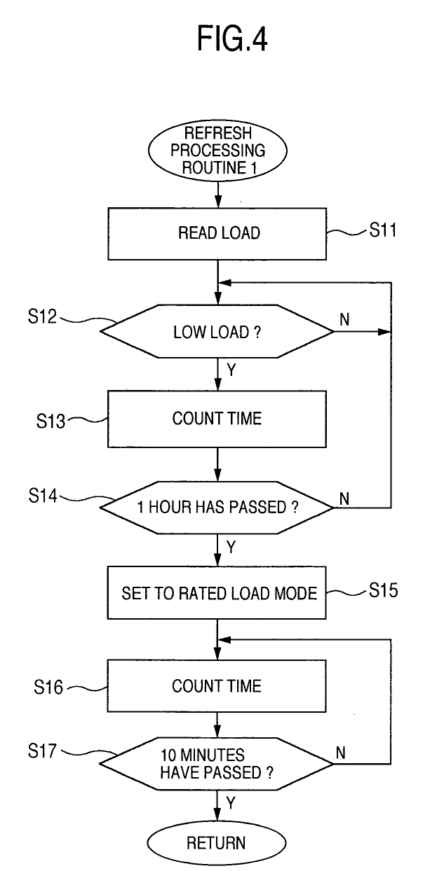

FIG. 4 is a flow chart for describing a refresh processing routine 1 which is executed by the control unit 50 every time a predetermined time has elapsed after the polymer electrolyte membrane fuel cell power generation system 1 according to the present invention has been initiated. When this routine 1 is commenced, the control unit 50 executes this refresh processing routine 1 in accordance with the below-mentioned execution steps.

That is to say, the control unit 50 reads a load of this system 1, which is detected by the AC ammeter provided in the power converting unit 30 (step S11). Next, the control unit 50 judges as to whether or not the load read in this step S11 amounts to 80% to 30% load (will be referred to as “low load” hereinafter) of the rated load (step S12). In this case that the control unit 50 judges that the load of this system 1 corresponds to the low load in the step S12, the control unit 50 counts time in synchronism with a clock at the same time when this judgement is made (step S13). The control unit 50 judges as to whether or not the time counted in the step S13 is reached to 1 hour (step S14). In such a case that the control unit 50 judges that the time counted in the step S14 is equal to 1 hour, a rated load mode signal is simultaneously outputted to both the hydrogen generating apparatus unit 10 and the oxidant gas supplying unit 60 by the signal processing means (step S15). This rated load mode signal forcibly causes the load of this system 1 to become the rated load. The control unit 50 counts time in synchronism with the clock at the same time when the rated load mode signal is outputted in the step S15 (step S16). The control unit 50 judges as to whether or not the time counted in the step S15 is reached to 10 minutes (step S17). When the control unit 50 judges that the time counted in the step S17 is reached to 10 minutes, the control unit 50 accomplishes this routine 1. In the case that the control unit 50 judges that the load of this system 1 is not brought into the low load in the step S12, the process operation is returned to the previous step S11 in which the control unit 50 again reads the load of the system 1. Also, in such a case that the control unit 50 judges that the time counted in the step S14 is not reached to 1 hour, the process operation is returned to the step S11, the control unit 50 again reads this count time. In such a case that the control unit 50 judges that the time counted in the step S17 is not reached to 10 minutes, the process operation is returned to the step S16, the control unit 50 again reads time until the counted time is reached to 10 minutes.

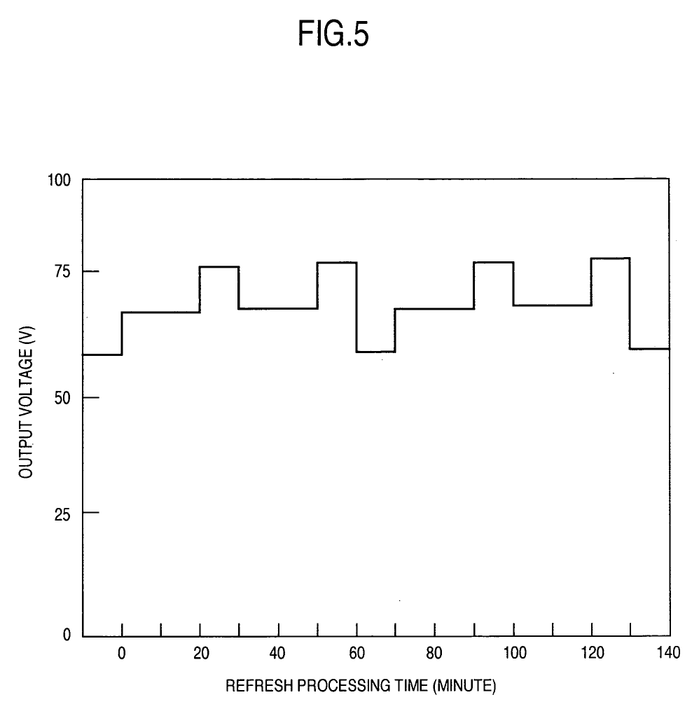

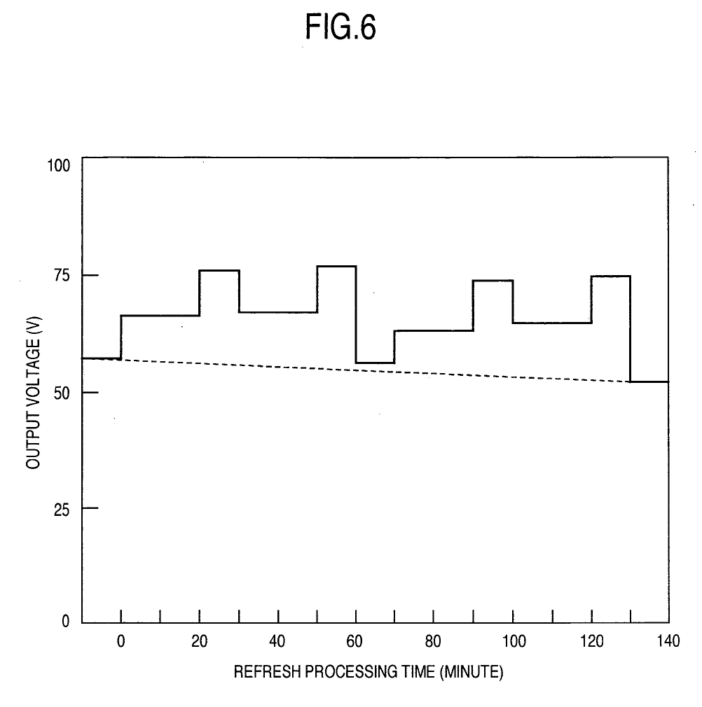

Next, both a comparison example and an embodiment of the above-described refresh processing routine 1 are shown. FIG. 5 is a graph for representing a relationship between a load and an output voltage of the fuel cell stack 200 at 350 hours after the operation of the polymer electrolyte membrane fuel cell power generation system 1 according to the present invention has been commenced. FIG. 6 is a graph as the comparison example in which the same refresh processing routine 1 is newly carried out at 350 hours after the operation of the polymer electrolyte membrane fuel cell power generation system 1 has been commenced. An ordinate of the graphs of FIG. 5 and FIG. 6 indicates the output voltage of the fuel cell stack 200, whereas an abscissa thereof shows time in the case that the operation is carried out in accordance with the above-described refresh processing routine 1. Concretely speaking, as the refresh processing routine 1, this refresh processing operation is executed for 20 minutes at a load of 50% with respect to the rated load, and thereafter, is executed for 10 minutes at a load of 30% with respect to the rated load, which are repeatedly carried out two times. Thereafter, the operation mode of the fuel cell stack 200 is forcibly set to the rated load mode, and a gas amount corresponding to the rated load is supplied to both the anode 203-a and the cathode 203-b. When this result of FIG. 5 is compared with the result of FIG. 6, such a fact can be understood that the output voltage shown in FIG. 5 becomes stable. In other words, FIG. 5 shows such a fact that since the refresh processing routine 1 is forcibly executed after this power generation system 1 has been commenced, the storage of water within the separator is little, so that lowering of the output voltage cannot be substantially observed and the output voltage is nearly equal to a constant voltage. On the other hand, FIG. 6 represents the following fact (broken line portion shows lowering trend of output voltage). That is, as a result obtained that the fuel cell stack 200 has been operated for a long time period based upon the power generation amount corresponding to the low load, water is stored inside the separator, and both the flows of the fuel gas within the anode 203-a and the flows of the air within the cathode become unequal, so that the output voltage is lowered. As a result, even when the refresh processing routine 1 is carried out, such an output voltage which has been once lowered cannot be again recovered up to the initial output voltage level.

As previously explained, the polymer electrolyte membrane fuel cell power operation system 1 according to the present invention can avoid that the water is stored inside the separator even when the operation of this power generation system 1 is carried out for the long time period under low load, since the refresh processing operation is forcibly carried out after this power generation system 1 has been commenced. As a consequence, since the flows of the fuel gas in the anode and the flows of the air in the cathode do not become unequal to each other, the polymer electrolyte membrane fuel cell power generation system 1 according to the present invention can perform the power generation operation under stable condition for the long time period while the output voltage is not substantially lowered.

### Embodiment 2

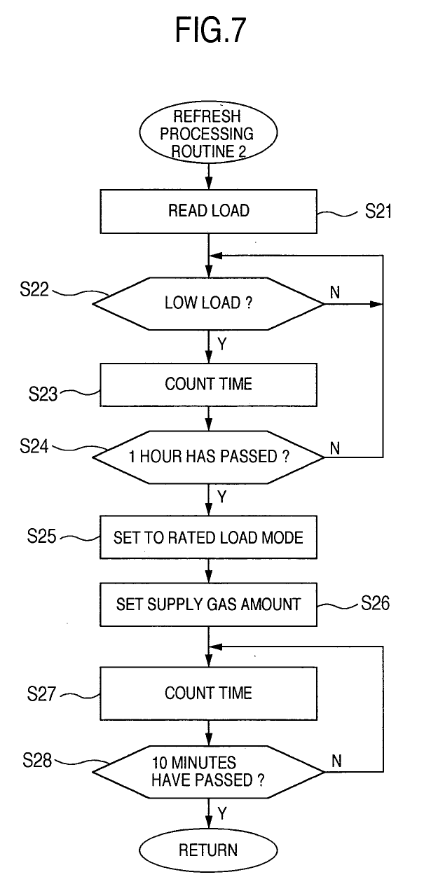

FIG. 7 is a flow chart for describing a refresh processing routine 2 which is executed by the control unit 50 every time a predetermined time has elapsed after the polymer electrolyte membrane fuel cell power generation system 1 according to the present invention has been initiated. In this refresh processing routine 2, both a step S21 to a step S25 and a step S26 to a step S28 except for a step S27 which is provided between the step S25 and the step S27 of the flow chart shown in FIG. 7 are common process steps with respect to the process steps defined from the step S11 to the step S17 of the refresh processing routine 1. As a consequence, while an explanation as to the common execution steps to the refresh processing routine 1 is omitted, executions of this refresh processing routine 2 by the control unit 50 will now be described in this embodiment 2.

That is to say, in this step S26, after the load mode has been set to the rated load mode in the step S25, such a setting signal is outputted to both the hydrogen generating apparatus unit 10 and the oxidant gas supplying unit 60. This setting signal is used to forcibly set both a fuel gas amount and an air amount which are supplied to the fuel cell unit 20 to a range of 100 to 200% of the rated load, preferably, a range of 130 to 170% thereof. In this case, if both a fuel gas amount and an air amount which are supplied are smaller than 100% of the rated load, then water contained in the separator cannot be effectively removed. On the other hand, if both a fuel gas amount and an air amount which are supplied are larger than 200% of the rated load, then the gas and the air are excessively supplied with respect to the water removing effect within the separator. As a result, a utilization efficiency of the fuel gas is especially deteriorated. In a step S27, the control unit 50 outputs the setting signal of this gas amount, and at the same time, counts time in synchronism with the clock. The control unit 50 judges as to whether or not the time counted in the step S27 is reached to 10 minutes in the next step S28. When the control unit 50 judges that the time counted in the step S27 is reached to 10 minutes, the control unit 50 accomplishes this routine 2 in this step S28.

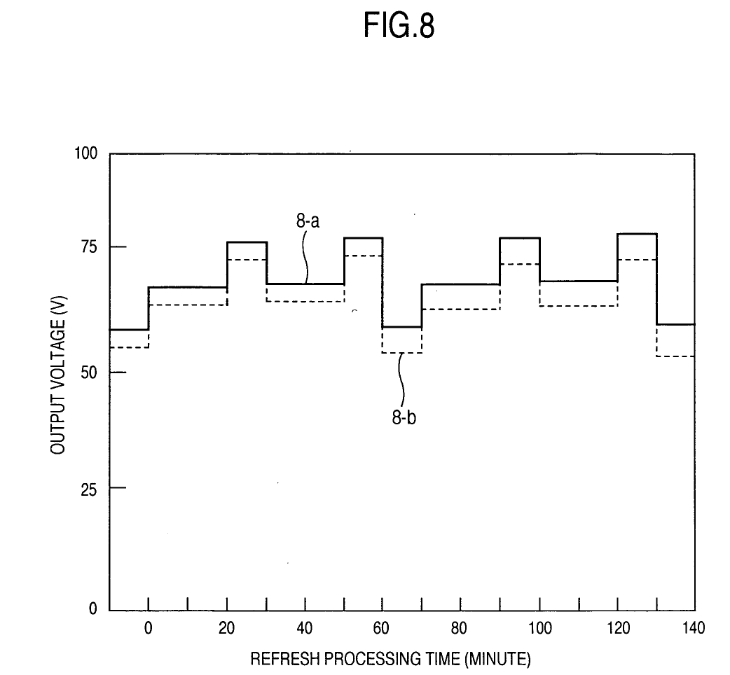

Next, both an embodiment of the above-described refresh processing routine 2 and a comparison example are indicated. A solid line portion (namely, line indicated by 8-a) of FIG. 8 is a graph for representing a relationship between a load and an output voltage of the fuel cell stack 200 at 750 hours after the operation of the polymer electrolyte membrane fuel cell power generation system 1 according to the present invention has been commenced. A broken line portion (namely, line indicated by 8-b) of FIG. 8 shows a graph as the comparison example in which the same refresh processing routine 2 is newly carried out at 750 hours after the operation of the polymer electrolyte membrane fuel cell power generation system 1 has been commenced. An ordinate of the graph of FIG. 8 indicates the output voltage of the fuel cell stack 200, whereas an abscissa thereof shows time in the case that the operation is carried out in accordance with the above-described refresh processing routine 2. Concretely speaking, as the refresh processing routine 2, this refresh processing operation 2 is executed for 20 minutes at a load of 50% with respect to the rated load, and thereafter, is executed for 10 minutes at a load of 30% with respect to the rated load, which are repeatedly carried out two times. Thereafter, the operation mode of the fuel cell stack 200 is forcibly set to the rated load mode, and then, both a fuel gas amount and an air amount of 150% of the rated load are supplied to the anode 202 for 10 minutes.

When the result shown in this solid line portion of FIG. 8 is compared with the result of such a comparison example (broken line portion of FIG. 8) that the same refresh processing routine 2 is newly carried out after the operation of the polymer electrolyte membrane fuel cell power generation system 1 has been commenced, it can been seen that the output voltage thereof becomes extremely stable. In other words, the broken line portion of FIG. 8 indicates the following fact. That is, as a result obtained that the fuel cell stack 200 has been operated for a long time period based upon the power generation amount corresponding to the low load, water is stored inside the separator, both the flows of the fuel gas within the anode 203-a and the flows of the air within the cathode 203-b become unequal, so that the output voltage is lowered. As a result, even when the refresh processing routine 2 is carried out, such an output voltage which has been once lowered cannot be again recovered up to the initial output voltage level. On the other hand, the solid line portion of FIG. 8 shows such a fact that since the refresh processing routine 2 is forcibly executed after this power generation system 1 has been commenced, the storage of water within the separator is little, so that lowering of the output voltage cannot be substantially observed.

As previously explained, the polymer electrolyte membrane fuel cell power generation system 1 according to the present invention can more firmly avoid that the water is stored inside the separator even when the operation of this power generation system 1 is carried out for the long time period under low load, since the refresh processing operation 2 is forcibly carried out after this power generation system 1 has been commenced. As a consequence, since the flows of the fuel gas in the anode and the flows of the air in the cathode do not become unequal to each other, the polymer electrolyte membrane fuel cell power generation system 1 according to the present invention can perform the power generating operation under stable condition for the long time period while the output voltage is not substantially lowered.

### Embodiment 3

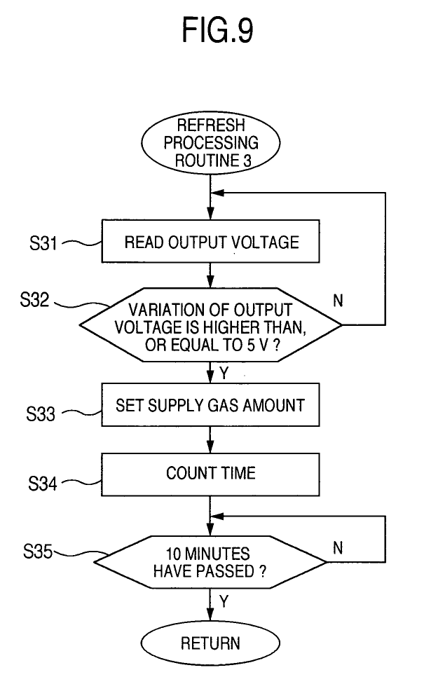

FIG. 9 is a flow chart for showing a refresh processing routine 3 which is executed by the control unit 50 every time a predetermined cell voltage is varied After the polymer electrolyte membrane fuel cell power generation system 1 according to the present invention has been commenced. When this refresh processing routine 3 is commenced, the control unit 50 executes this refresh processing routine 3 in accordance with the below-mentioned steps. That is, the control unit 50 firstly reads an output voltage of the fuel cell stack 200 of this power generation system 1, which has been detected by a voltmeter provided in the fuel cell unit 20 (step S31). Next, the control unit 50 judges as to whether or not a variation of the output voltage of this fuel cell stack 200 is higher than, or equal to 5 V (step S32). In this case, the variation of the output voltage implies such a voltage difference that an output voltage under the rate load is compared with an initial output voltage (60 V) under the rate load. In the step S32, in the case that the control unit 50 judges that this variation of the output voltage of the fuel cell stack 200 is higher than, or equal to 5 V, such a setting signal is simultaneously outputted to both the hydrogen generating apparatus unit 10 and the oxidant gas supply unit 60 by the signal processing means (step S33). This setting signal forcibly sets a gas amount supplied to the fuel cell unit 20 to such a range of 100 to 200% of the rated load, preferably, a range of 130 to 170% of the rated load. When the signal is outputted in the step S33, at the same time, the control unit 50 counts time in synchronism with the clock (step S34). Next, the control unit 50 judges as to whether or not the time counted in the step S34 is reached to 10 minutes (step S35). In the case that the control unit 50 judges that the counted time is reached to 10 minutes in the step S35, the control unit 50 accomplishes this refresh processing routine 3.

In the case that the control unit 55 does judge in the step S32 that this variation of the output voltage of the fuel cell stack 200 is higher than, or equal to 5 V, the control unit 50 again reads the output voltage of the fuel cell stack 200 in a step S31. When the control unit 50 judges in the step S35 that the counted time is not reached to 10 minutes, the process operation is returned to the step S34 in which the control unit 50 again reads the output voltage until the counted time is reached to 10 minutes.

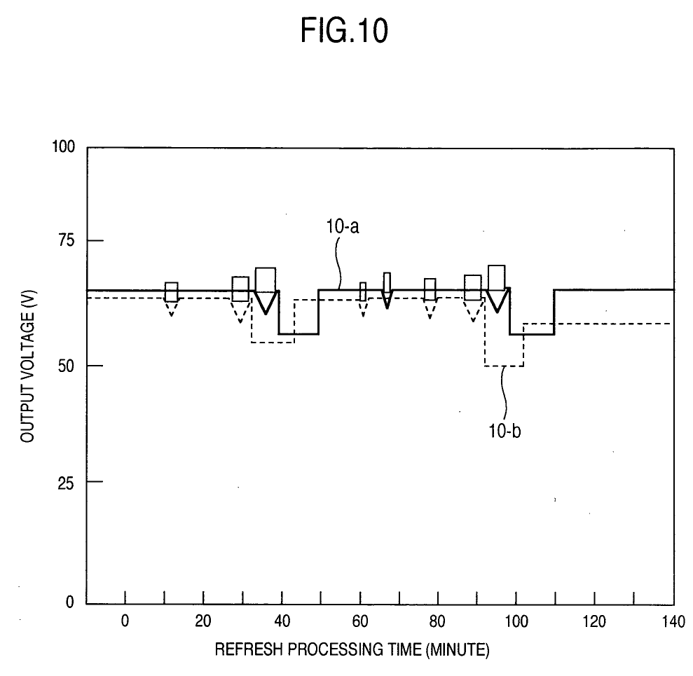

Next, both an embodiment of the above-described refresh processing routine 3 and a comparison example are indicated. A solid line portion (namely, line indicated by 10-a) of FIG. 10 is a graph for representing a relationship between a load and an output voltage of the fuel cell stack 200 at 350 hours after the operation of the polymer electrolyte membrane fuel cell power generation system 1 according to the present invention has been commenced. A broken line portion (namely, line indicated by 10-b) of FIG. 10 shows a graph as the comparison example in which the same refresh processing routine 3 is newly carried out at 350 hours after the operation of the polymer electrolyte membrane fuel cell power generation system 1 has been commenced. An ordinate of the graph of FIG. 10 indicates the output voltage of the fuel cell stack 200, whereas an abscissa thereof shows time in the case that the operation is carried out in accordance with the above-described refresh processing routine 3. Concretely speaking, as the refresh processing routine 3, in such a case that the control unit 50 judges that the variation of the output voltage of the fuel cell stack 200 is higher than, or equal to 5 V, both a fuel gas amount and an air amount which correspond to 150% of the rated load are forcibly supplied to the fuel cell stack 200 in the fuel cell unit 20 for 10 minutes. When the result shown in this solid line portion of FIG. 10 is compared with the result of such a comparison example (broken line portion of FIG. 10) that the same refresh processing routine 3 is newly carried out at 350 hours under operation of 50% of the rated load after the operation of the polymer electrolyte membrane fuel cell power generation system 1 has been commenced, it can been seen that the output voltage thereof becomes stable. In other words, the broken line portion of FIG. 10 indicates the following fact. That is, as a result obtained that the fuel cell stack 200 has been operated for a long time period based upon the power generation amount corresponding to the low load, water is stored inside the separator, both the flows of the fuel gas within the anode 203-a and the flows of the air within the cathode 203-a and the flows of the air within the cathode 203-b become unequal, so that the recovered output voltage is again lowered within a short time. As a result, even when the refresh processing routine 3 is carried out, since the water which has been stored inside the separator can be hardly removed, the recovered output voltage is again lowered within the short time. On the other hand, the solid line portion of FIG. 10 shows such a fact that since the refresh processing routine 3 is forcibly executed after this power generation system 1 has been commenced, the storage of water within the separator is little, so that lowering of the output voltage cannot be substantially observed.

As previously explained, the polymer electrolyte membrane fuel cell power generation system 1 according to the present invention can avoid that the water is stored inside the separator even when the operation of this power generation system 1 is carried out for the long time period under low load, since the refresh processing operation 3 is forcibly carried out after this power generation system 1 has been commenced. As a consequence, since the flows of the fuel gas in the anode and the flows of the air in the cathode do not become unequal to each other, the polymer electrolyte membrane fuel cell power generation system 1 according to the present invention can perform the power generating operation under stable condition for the long time period while the output voltage is not substantially lowered.

### Embodiment 4

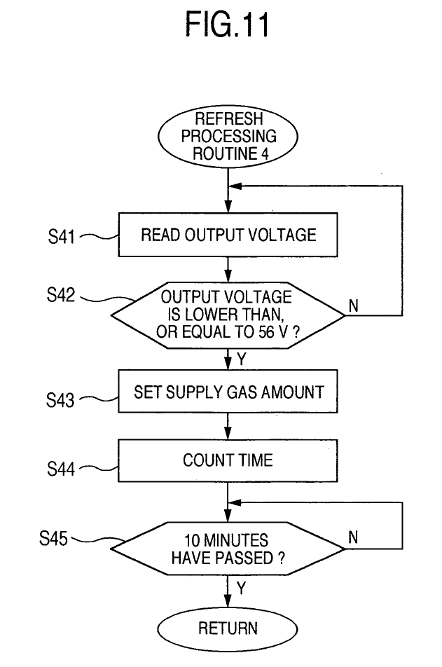

FIG. 11 is a flow chart for showing a refresh processing routine 4 which is executed by the control unit 50 every time the cell voltage is lowered than, or equal to a predetermined cell voltage after the polymer electrolyte membrane fuel cell power generation system 1 according to the present invention has been commenced. When this refresh processing routine 4 is commenced, the control unit 50 firstly reads an output voltage of the fuel cell stack 200 of this power generation system 1, which has been detected by a voltmeter provided in the fuel cell unit 20 (step S41). Next, the control unit 50 judges as to whether or not an output voltage of this fuel cell stack 200 under the rated load is lower than, or equal to 56 V (step S42). In the case that the control unit 50 judges in this step S42 that the output voltage of the fuel cell stack 200 under the rated load is lower than, or equal to 56 V, the control unit 50 outputs such a setting signal to the hydrogen generating apparatus unit 10 (step S43). This setting signal sets a gas amount supplied to the anode 202 to such a range of 100 to 200% of the rated load, preferably, a range of 130 to 170% of the rated load. When the signal is outputted in the step S43, at the same time, the control unit 50 counts time in synchronism with the clock (step S44). Next, the control unit 50 judges as to whether or not the time counted in the step S44 is reached to 10 minutes (step S45). In the case that the control unit 50 judges that the counted time is reached to 10 minutes in the step S45, the control unit 50 accomplishes this refresh processing routine 4. In the case that the control unit 55 does not judge in the step S42 that this output voltage of the fuel cell stack 200 is lower than, or equal to 56 V, the control unit 50 again reads the output voltage of the fuel cell stack 200, while returning back to the step S41. Also, in the step S45, in such a case that the fuel gas of this set concentration is not supplied for more than 10 minutes, the process operation is returned to the step S44 in which the control unit 50 is brought into a waiting status until the fuel gas of this set concentration is supplied for more than 10 minutes.

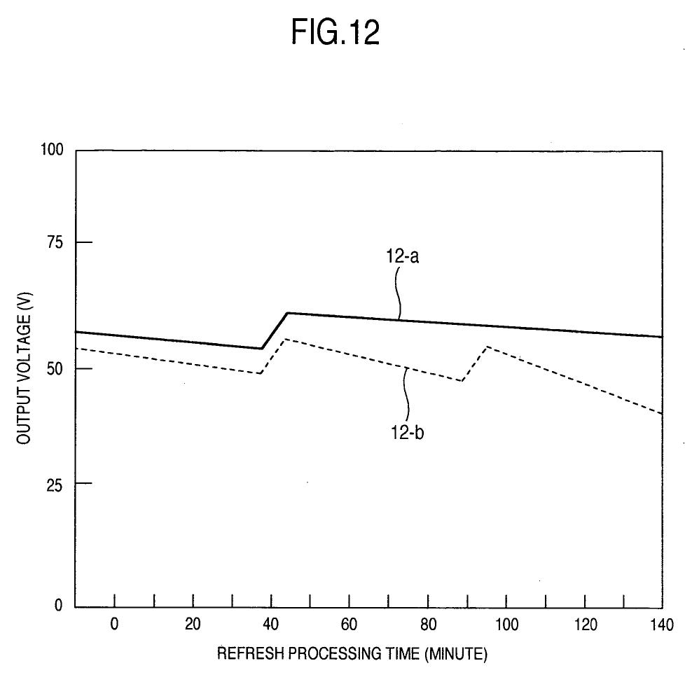

Next, both an embodiment of the above-described refresh processing routine 4 and a comparison example are indicated. A solid line portion (namely, line indicated by 12-a) of FIG. 12 is a graph for representing a relationship between a load and an output voltage of the fuel cell stack 200 at 350 hours after the operation of the polymer electrolyte membrane fuel cell power generation system 1 according to the present invention has been commenced. A broken line portion (namely, line indicated by 12-b) of FIG. 12 shows a graph as the comparison example in which the same refresh processing routine 4 is newly carried out at 350 hours after the operation of the polymer electrolyte membrane fuel cell power generation system 1 has been commenced. An ordinate of the graph of FIG. 12 indicates the output voltage of the fuel cell stack 200, whereas an abscissa thereof shows time in the case that the operation is carried out in accordance with the above-described refresh processing routine 4. Concretely speaking, as the refresh processing routine 4, in the case that the control unit 50 judges that an output voltage of the fuel cell stack 200 is lower than, or equal to 56 V, hydrogen concentration of the fuel gas is forcibly set to such a concentration of 130%, and the fuel gas is supplied to the anode 202 of the fuel cell stack 200 for 10 minutes. In this case, if the hydrogen concentration of the fuel gas to be supplied is smaller than that of 100% of the rated load, then the oxidation film of the electrode catalyst surface cannot be effectively removed. On the other hand, if the hydrogen concentration of the fuel gas to be supplied is larger than that of 200% of the rated load, then the fuel gas is excessively supplied with respect to the effect of removing the oxidation film of the electrode catalyst surface, so that the utilization efficiency of the fuel gas is deteriorated. When the result shown in this solid line portion of FIG. 12 is compared with the result of such a comparison example (broken line portion of FIG. 12) that the same refresh processing routing 4 is newly carried out at 350 hours under operation of the rated load after the polymer electrolyte membrane fuel cell power generation system 1 has been commenced, it can been seen that the output voltage thereof becomes stable. In other words, the broken line portion of FIG. 12 indicates the following fact. That is as a result obtained that the fuel cell stack 200 has been operated for a long time period, the output voltage is lowered due to deteriorations of the performance which are caused by the oxidation of the electrode catalyst by the air which has been mixed from the cathode 203-a to the anode 203-b in the crossover phenomenon. As a result, even if the refresh processing routine 4 has been carried out, such an output voltage which has been once lowered cannot be again recovered up to the initial output voltage level. On the other hand, the solid line portion of FIG. 12 shows such a fact that since the refresh processing routine 4 is forcibly executed after this power generation system 1 has been commenced although the operation has been continuously performed, the performance deterioration of the catalyst of the anode is little, so that lowering of the output voltage cannot be substantially observed.

As previously explained, the polymer electrolyte membrane fuel cell power generation system 1 according to the present invention can avoid that the catalyst performance of the anode is deteriorated even when the operation of this power generation system 1 is carried out for the long time period under low load, since the refresh processing operation 4 is forcibly carried out after this power generation system 1 has been commenced. As a consequence, since the catalyst performance of the anode is maintained, the polymer electrolyte membrane fuel cell power generation system 1 according to the present invention can perform the power generating operation under stable condition for the long time period while the output voltage is not substantially lowered.

### Embodiment 5

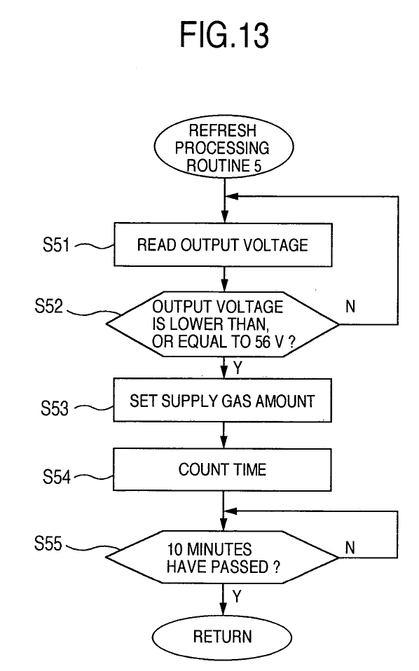

FIG. 13 is a flow chart for showing a refresh processing routine 5 which is executed by the control unit 50 every time the cell voltage is lower than, or equal to a predetermined cell voltage after the polymer electrolyte membrane fuel cell power generation system 1 according to the present invention has been commenced. When this refresh processing routine 5 is commenced, the control unit 50 firstly reads an output voltage of the fuel cell stack 200 of this power generation system 1, which has been detected by the voltmeter provided in the fuel cell unit 20 (step S51). Next, the control unit 50 judges as to whether or not an output voltage of this fuel cell stack 200 under the rated load is lower than, or equal to 56 V (step S52). In the case that the control unit 50 judges in this step S52 that the output voltage of the fuel cell stack 200 under the rated load is lower than, or equal to 56 V, the control unit 50 outputs such a setting signal to the hydrogen generating apparatus unit 10 (step S53). This setting signal sets hydrogen concentration of fuel gas supplied to the anode 202 to such a range of 100 to 200% of the rated load, preferably, a range of 100 to 150% of the rated load. When the signal is outputted in the step S53, at the same time, the control unit 50 counts time in synchronism with the clock (step S54). Next, the control unit 50 judges as to whether or not the time counted in the step S54 is reached to 10 minutes (step S55). In the case that the control unit 50 judges that the counted time is reached to 10 minutes in the step S55, the control unit 50 accomplishes this refresh processing routine 5. In the case that the control unit 55 does not judge in the step S32 that this output voltage of the fuel cell stack 200 is lower than, or equal to 56 V, the control unit 50 again reads the output voltage of the fuel cell stack 200 while returning back to the step S51. Also, in the step S55, in such a case that the fuel gas of this set concentration is not supplied for more than 10 minutes, the process operation is returned to the step S54 in which the control unit 50 is brought into a waiting status until the fuel gas of this set concentration is supplied for more than 10 minutes.

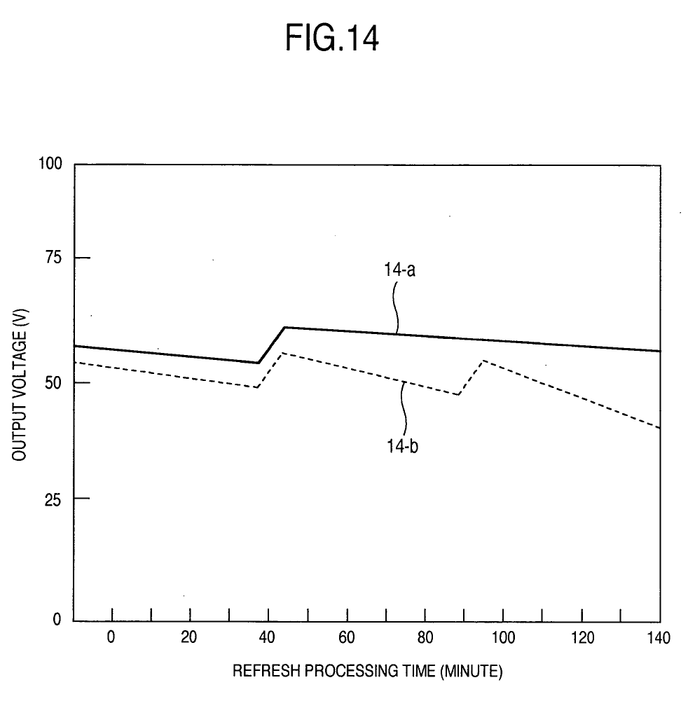

Next, both an embodiment of the above-described refresh processing routine 5 and a comparison example are indicated. A solid line portion (namely, line indicated by 14-a) of FIG. 14 is a graph for representing a relationship between a load and an output voltage of the fuel cell stack 200 at 350 hours after the operation of the polymer electrolyte membrane fuel cell power generation system 1 according to the present invention has been commenced. A broken line portion (namely, line indicated by 14-b) of FIG. 14 shows a graph as the comparison example in which the same refresh processing routine 5 is newly carried out at 350 hours after the operation of the polymer electrolyte membrane fuel cell power generation system 1 has been commenced. An ordinate of the graph of FIG. 14 indicates the output voltage of the fuel cell stack 200, whereas an abscissa thereof shows time in the case that the operation is carried out in accordance with the above-described refresh processing routine 5. Concretely speaking, as the refresh processing routine 5, in the case that the control unit 50 judges that an output voltage of the fuel cell stack 200 is lower than, or equal to 56 V, hydrogen concentration of the fuel gas is forcibly set to such a concentration of 130%, and the fuel gas is supplied to the anode 202 of the fuel cell stack 200 for 10 minutes. In this case, if the hydrogen concentration of the fuel gas to be supplied is smaller than that of 100% of the rated load, then the oxidation film of the electrode catalyst surface cannot be effectively removed.

On the other hand, if the hydrogen concentration of the fuel gas to be supplied is larger than that of 200% of the rated load, then the fuel gas is excessively supplied with respect to the effect of removing the oxidation film of the electrode catalyst surface, so that the utilization efficiency of the fuel gas is deteriorated. When the result shown in this solid line portion of FIG. 14 is compared with the result of such a comparison example (broken line portion of FIG. 14) that the same refresh processing routine 5 is newly carried out at 750 hours under operation of the rated load after the polymer electrolyte membrane fuel cell power generation system 1 has been commenced, it can been seen that the output voltage thereof becomes stable. In other words, the broken line portion of FIG. 14 indicates the following fact. That is, as a result obtained that the fuel cell stack 200 has been operated for a long time period, the output voltage is lowered due to deteriorations of the performance which are caused by the oxidation of the electrode catalyst by the air which has been mixed from the cathode 203-a to the anode 203-b in the crossover phenomenon. As a result, even when the refresh processing routine 5 has been carried out, such an output voltage which has been once lowered cannot be again recovered up to the initial output voltage level. On the other hand, the solid line portion of FIG. 14 shows such a fact that since the refresh processing routine 5 is forcibly executed after this power generation system 1 has been commenced although the operation has been continuously performed, the performance deterioration of the catalyst of the anode is little, so that lowering of the output voltage cannot be substantially observed.

As previously explained, the polymer electrolyte membrane fuel cell power generation system 1 according to the present invention can avoid that the catalyst performance of the anode is deteriorated even when the operation of this power generation system 1 is carried out for the long time period under low load, since the refresh processing operation 5 is forcibly carried out after this power generation system 1 has been commenced. As a consequence, since the catalyst performance of the anode is maintained, the polymer electrolyte membrane fuel cell power generation system 1 according to the present invention can perform the power generating operation under stable condition for the long time period while the output voltage is not substantially lowered.

### Other Embodiments

The control unit 50 compares a signal of a load which is detected by the AC ammeter employed in the power converting unit 30 with a signal of generated electric power which is detected by the voltmeter provided in the fuel cell unit 20, and when the generated electric power is larger than the load, the control unit 50 outputs such a signal by which generated dump electric power is charged into the power storage means 32 provided in the power converting unit 30. Also, when a load is larger than the generated electric power, the control unit 50 outputs such a signal for discharging electric power to the power storage unit 32 in order to back up a shortage component of the generated power. This back-up purpose power storage means 32 may be realized by any means such as a secondary battery and a capacitor, which is capable of charging/discharging electric power. As this secondary battery, any secondary batteries known in this field may be employed, for instance, a lead battery, a nickel-hydrogen secondary battery, a nickel-cadmium secondary battery, and a lithium secondary battery may be employed. As the capacitor, any capacitors known in the field may be employed, for instance, a large capacitance electrolyte capacitor may be employed which will also be referred to as a “ultra capacitor (otherwise, super capacitor).” It should also be noted that this back-up purpose power storage means 32 may also constitute an initiation-purpose power supply.

The control unit 50 also compares a signal of a load which is detected by the AC ammeter employed in the power converting unit 30 with a signal of generated electric power which is detected by the voltmeter provided in the fuel cell unit 20, and when the generated electric power is larger than the load, the control unit 50 outputs such a signal to a heater 42 which is provided within a hot-water storage tank 41. This signal causes this generated dump electric power to heat hot water. As the heater 42, any heaters known in the field may be employed, for instance, a resistance heating heater for converting electric energy into heat may be employed.

### APPLICATION EXAMPLE

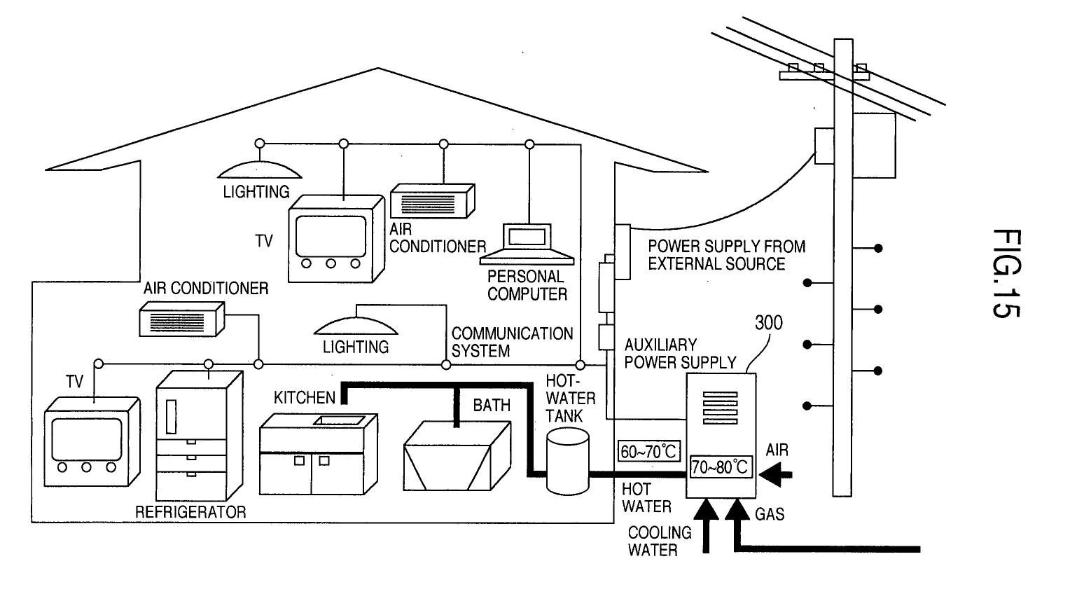

FIG. 15 illustratively shows an example in which the polymer electrolyte membrane fuel cell power generation system according to the present invention is employed as a home-use stationary type distributed power supply 300, which corresponds to an application example of this polymer electrolyte membrane fuel cell power generation system. The home-use stationary type distributed power supply 300 corresponds to such a distributed power supply system that fuel gas such as city gas which has been supplied outside the home is reformed to hydrogen gas by a reforming device of a hydrogen generating apparatus installed in the home-use stationary type distributed power supply 300, and this hydrogen fuel is supplied to a fuel cell, and then, electric power is generated by this fuel cell while employing this hydrogen fuel and the externally supplied air. A fuel cell owns such a feature that electric power is generated by utilizing an electrochemical reaction, and at the same time, heat is generated. In the case that a polymer electrolyte membrane fuel cell is employed, since a temperature of this fuel cell during power generation is continuously maintained at approximately 70 to 80 degrees, cooling water is supplied inside the fuel cell so as to eliminate both the above-described reaction heat and resistance heat which is produced inside the fuel cell during the power generation. In the home-use stationary type distributed power supply 300, the heat which has been eliminated by this cooling water is collected in the form of hot water.

There are some possibilities that if externally supplied water is directly used so as to cool a fuel cell, then the fuel cell may be adversely influenced such as corrosion by an impurity, for example, chloride ions and metal ions such as iron and copper which are contained in this water. In such a case, the temperature of the externally supplied water may be indirectly increased by a means having a heat exchanging function such as a heat exchanger so as to produce hot water. Since the hot water which has been produced by utilizing this heat collection may become hot water having a temperature of, for example, 50 to 60 degrees, if this hot water is stored in a hot-water tank and is used, then hot water which is used in a home equipment such as a kitchen and a bath may be provided instead of a hot-water supplying device. In addition, since the electric power which has been obtained by the power generation is utilized as power supplies for various sorts of electric appliances within the home in combination with externally supplied electric power, the amount of the externally supplied electric power may be reduced. Apparently, if the power generation amount of the fuel cell becomes larger than the electric power used in the home, then no electric power is supplied outside the home. Also, in such a case that either the power generation amount of the fuel cell or the electric power used in the home is varied and thus a power balance becomes unbalanced, an adverse influence given to this home-use stationary type distributed power supply 300 may be reduced by employing the secondary battery, or the like, which has been provided as the power storage means.

As previously explained, although the home-use stationary type distributed power supply which has employed the polymer electrolyte membrane fuel cell power generation system is such a home-use distributed power supply whose load variation is large, since the refresh processing operation of the fuel cell can be carried out in a proper manner, the home-use stationary type distribution power supply can be operated under stable condition for a long time period as a co-generation system having a high energy efficiency.

It should be further understood by those skilled in the art that although the foregoing description has been made on embodiments of the invention, the invention is not limited thereto and various changes and modifications may be made without departing from the spirit of the invention and the scope of the appended claims.

1. A polymer electrolyte membrane fuel cell power generation system comprising:
a fuel cell unit equipped with a fuel cell stack for stacking a unit cell which is arranged by a polymer electrolyte membrane, both anode and cathode which are provided by sandwiching therebetween said polymer electrolyte membrane, a first separator having a channel for supplying/exhausting fuel gas, which is provided outside said anode, and also, a second separator having a channel for supplying/exhausting air, which is provided outside said cathode;
a hydrogen generating apparatus unit for supplying the fuel gas to said fuel cell unit;
an oxidant gas supplying unit for supplying oxidant gas to said fuel cell unit;
a power converting unit for converting DC power generated from said fuel cell unit into AC power so as to supply the AC power to a load;
a heat collecting unit for collecting heat which is produced from said fuel cell unit;
a load detecting unit for detecting a load supplied by said power converting unit; and
a control unit for controlling said fuel cell unit, said hydrogen generating apparatus unit, said oxidant gas supplying unit, said power converting unit, and said heat collecting unit; wherein:
said control unit owns a function capable of controlling that when a load detected by said load detecting unit is not equal to a predetermined time rated load, said fuel cell unit is operated in a power generation mode corresponding to the predetermined time rated load.

2. A polymer electrolyte membrane fuel cell power generation system as claimed in claim 1 wherein:
said control unit owns a function capable of controlling that when said fuel cell unit is operated in the power generation mode corresponding to the predetermined time rated load, both an amount of the fuel gas and an amount of the oxidant gas which are supplied to said fuel cell unit are supplied at a rate of 100 to 200% of gas supply amounts which correspond to a power generation mode of a rated load.

3. A polymer electrolyte membrane fuel cell power generation system comprising:
a fuel cell unit equipped with a fuel cell stack for stacking a unit cell which is arranged by a polymer electrolyte membrane, both anode and cathode which are provided by sandwiching therebetween said polymer electrolyte membrane, a first separator having a channel for supplying/exhausting fuel gas, which is provided outside said anode, and also, a second separator having a channel for supplying/exhausting air, which is provided outside said cathode;
a hydrogen generating apparatus unit for supplying the fuel gas to said fuel cell unit;
an oxidant gas supplying unit for supplying oxidant gas to said fuel cell unit;
a power converting unit for converting DC power generated from said fuel cell unit into AC power so as to supply the AC power to a load;
a heat collecting unit for collecting heat which is produced from said fuel cell unit;
a voltage detecting unit for detecting a cell voltage of said fuel cell unit; and
a control unit for controlling said fuel cell unit, said hydrogen generating apparatus unit, said oxidant gas supplying unit, said power converting unit, and said heat collecting unit; wherein:
said control unit owns a function capable of controlling that when a variation of the cell voltage detected by said voltage detecting unit is higher than, or equal to a predetermined voltage, both an amount of the fuel gas and an amount of the oxidant gas which are supplied to said fuel cell unit are supplied at a rate of 100 to 200% of gas supply amounts which correspond to a power generation mode of a rated load.

4. A polymer electrolyte membrane fuel cell power generation system comprising:
a fuel cell unit equipped with a fuel cell stack for stacking a unit cell which is arranged by a polymer electrolyte membrane, both anode and cathode which are provided by sandwiching therebetween said polymer electrolyte membrane, a first separator having a channel for supplying/exhausting fuel gas, which is provided outside said anode, and also, a second separator having a channel for supplying/exhausting air, which is provided outside said cathode;
a hydrogen generating apparatus unit for supplying the fuel gas to said fuel cell unit;
an oxidant gas supplying unit for supplying oxidant gas to said fuel cell unit;
a power converting unit for converting DC power generated from said fuel cell unit into AC power so as to supply the AC power to a load;
a heat collecting unit for collecting heat which is produced from said fuel cell unit;
a voltage detecting unit for detecting a cell voltage of said fuel cell unit; and
a control unit for controlling said fuel cell unit, said hydrogen generating apparatus unit, said oxidant gas supplying unit, said power converting unit, and said heat collecting unit; wherein:
said control unit owns a function capable of controlling that when a cell voltage detected by said voltage detecting unit is lower than, or equal to a predetermined voltage, both an amount of the fuel gas and an amount of the oxidant gas which are supplied to said fuel cell unit are supplied at a rate of 100 to 200% of gas supply amounts which correspond to a power generation mode of a rated load.

5. A polymer electrolyte membrane fuel cell power generation system as claimed in claim 4 wherein:
said control unit owns a function capable of controlling that when the cell voltage detected by said voltage detecting unit is lower than, or equal to the predetermined voltage, fuel gas is supplied from said hydrogen generating apparatus unit to said fuel cell unit, the concentration of which is set to a rate of 100 to 200% of such fuel gas concentration corresponding to the power generation mode of the rated load.

6. A polymer electrolyte membrane fuel cell power generation system as claimed in claim 1 wherein:
said power converting unit is comprised of a rechargeable secondary battery; and
said control unit owns a function capable of controlling that when electric power generated by said fuel cell unit becomes excessive with respect to the load power detected by said load detecting unit, said excessive power is charged into said secondary battery, whereas when electric power generated by said fuel cell unit becomes short with respect to the load power detected by said load detecting unit, said shortage power is discharged from said secondary battery.

7. A polymer electrolyte membrane fuel cell power generation system as claimed in claim 1 wherein:
said power converting unit is comprised of a rechargeable capacitor; and
said control unit owns a function capable of controlling that when electric power generated by said fuel cell unit becomes excessive with respect to the load power detected by said load detecting unit, said excessive power is charged into said rechargeable capacitor, whereas when electric power generated by said fuel cell unit becomes short with respect to the load power detected by said load detecting unit, said shortage power is discharged from said rechargeable capacitor.

8. A polymer electrolyte membrane fuel cell power generation system as claimed in claim 1 wherein:
said heat collecting unit is comprised of a heating means; and
said control unit owns a function capable of controlling that when electric power generated by said fuel cell unit becomes excessive with respect to the load power detected by said load detecting unit, said excessive power is converted into heat by said heating means so as to collect the heat.

9. A home-use stationary distributed power supply system comprising:
the polymer electrolyte membrane fuel cell power generation system recited in claim 1.
